(19) United States
(12) Patent Application Publication
(10) Pub. No.: US 2007/0012501 A1
(43) Pub. Date: Jan. 18, 2007

(54) Protective device for lines, in particular fluid lines, in motor vehicles

(75) Inventors: Oliver Frank, Weil der Stadt (DE); Stefan Froschauer, Jettingen (DE); Christoph Mueller, Stuttgart (DE); Claudia Reinberg, Sindelfingen (DE); Jochen Ruf, Pforzheim (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/481,028

(22) Filed: Jul. 6, 2006

(30) Foreign Application Priority Data
Jul. 16, 2005 (DE) 10 2005 033 335.4

(51) Int. Cl. B60K 5/00

(52) U.S. Cl. 180/232

(57) ABSTRACT

A protective cap is provided as the protective device for lines which are laid in the engine compartment of vehicles and are situated in the crash-induced displacement region of the engine. The protective cap is to be fitted on the engine and is supported in a three-dimensionally secured manner with respect to the engine against engine projections during crash-induced loads.

This application claims the priority of German application 10 2005 033 335.4, filed Jul. 16, 2005, the disclosure of which is expressly incorporated by reference herein.

### BACKGROUND AND SUMMARY OF THE INVENTION

This invention relates to a protective device for lines, such as fluid lines in a motor vehicle with sections situated in an engine compartment of the motor vehicle, which is configured so that during accident-induced displacements of an engine towards a passenger compartment, the device intersects with a displacement region of the engine. The device includes a protective arrangement for the lines provided on the engine.

Engine compartments of motor vehicles, such as passenger vehicles, are frequently occupied up to the limits of what is possible. This is caused by the requirement for a spacious design of the passenger compartment and, in the case of a resultantly provided small engine compartment, the need to accommodate a multiplicity of assemblies in addition to the engine in the engine compartment. In vehicles with front engines, design factors, such as, for example, hoods or bonnets with shallow downward slopes, additionally restrict the amount of space offered. With accident-induced body deformations and/or displacements of the engine and the assemblies assigned thereto, dense engine compartment packing also can cause damage to line systems running in engine compartments, and particularly to fuel-conducting lines, with a resultant fire risk.

In a protective device known from German document DE 44 24 165 A1, with a front engine which is installed transversely and is inclined rearwards, intake pipes which protrude forwards and upwards on the cylinder-head side and are intended for injection valves situated in the region of the intake pipes, and fuel lines connected to the injection valves, there is the risk of damage if a crash causes the engine to be displaced towards the splashboard delimiting the engine compartment from the interior. To protect the injection valves and the fuel lines connected to them, the intake pipes are therefore connected to web plates which extend from the intake pipes towards the cylinder head covering, overlapping the angular region in the transition to the cylinder head covering, and end in the vicinity of the cylinder head covering. As a result, based on a pivoting movement of the intake pipes in the direction of the cylinder head covering, when bearing against the cylinder head covering, the web plates form angled plates stiffening the intake pipes. By means of the arrangement of the injection valves in the region of these angled plates and the running of the fuel lines, which lead to the injection valves and extend in the longitudinal direction of the engine, in cutouts open on the border of these angled plates, a protected position of the injection valves and of the fuel lines is sought. A bending of the intake pipes in the direction of the cylinder head covering, which could lead to injection valves and fuel lines being damaged, is also prevented. Such protective devices on the engine signify a further restriction of the available space and, in particular, are also not desirable from the point of view of service and repair work.

In addition, it is known from German document DE 20 2004 011 555 U1 to provide structural components which serve to shield thermal radiators such as chargers and the like, which are planar in a shell-shaped manner, which are sufficiently stiffened by shaping and ribbing and, as a result, which can be used as relatively large shielding parts which are even resistant to vibrations.

One object of this invention is the object of configuring a protective device of the type mentioned so that, with little structural outlay and space being required, safety-relevant damage to lines, in particular fuel-conducting fluid lines, caused by crash-induced displacements of the engine are avoided.

This is achieved according to the invention without intervening in or changing the factors caused by design or manufacturing and taking the indispensable crash-induced displacements of engine and assemblies into account, while accepting, if appropriate, loads on the lines, but restricting them to an extent still permissible under safety-critical aspects. For this purpose, the engine is provided with a protective arrangement which is formed by a protective cap which covers an edge region facing the passenger compartment, in particular a corner region of the engine, which is particularly critical from the point of view of line damage.

Corner regions of this type are produced, for example, in the manufacturing process by machining the engine blocks, inter alia, in the rear region of the engine, which is installed longitudinally with respect to the vehicle, i.e. in particular in the cylinder head region, and lead to sharp, aggressively shaped edges. To render these harmless using manufacturing measures would mean a high outlay. When the engine is displaced rearwards in a head-on crash, edges of this type form a risk to lines running in the displacement region of the engine, particularly since, when the engine is displaced, the lines can be squeezed between the engine and structural parts forming a delimitation with respect to the passenger compartment, and in particular the front wall, and these lines may be severed when acted upon by a sharp edge.

By arranging the protective cap provided according to the invention on the engine, such sharp-edged regions can be shielded with an extremely low outlay, particularly since it is possible within the scope of the invention, virtually without any additional outlay, to match the shaping of the protective cap to the region against which the lines are pressed by the engine displaced towards the passenger compartment, so that correspondingly large loads are produced on the lines. In accordance with its matching in terms of shaping, or else in addition thereto, the protective cap can be of self-deforming design to a certain extent, for example over the dimensioning of its wall thicknesses, with the result that spot-wise loads on the lines are thereby avoided.

Within the scope of the invention, it is advantageous to configure the shaping of the protective cap in such a manner that, in the event of a crash, with reference to the load directions of the protective cap during crash-induced displacement of the engine, the protective cap is supported against the engine in planes offset at an angle to one another, so that the protective cap is virtually supported in a form-fitting manner with respect to the engine, and the installation-necessitated fastening of the protective cap with respect to the engine, for example via a screw connection, only has to absorb low loads.

This is achieved by providing the protective cap with formations which overlap engine projections, such as, for example, cylinder head ribbings. As a result, given an appropriate profile of these ribbings and/or of cylinder-head projections provided transversely to the ribbings running in the vertical direction of the engine and/or by the overlap of screw connections, such as cylinder head screw connections, a multi-dimensional support is provided for the protective cap.

Overall, the support is preferably configured in such a manner that, firstly, a sufficiently large supporting surface which, if a screw connection is provided, stabilizes the protective cap is provided between protective cap and engine, for example for the screw fastening. Secondly, overlapping surfaces are provided which, in the event of a load, lead to a multi-dimensional support, so that the loads occurring in the event of a crash essentially do not have to be absorbed via the fastening formed by the screw connection of the protective cap.

It has also proven expedient, in particular when the protective cap is arranged in the region of add-on parts or manifolds, to use, for example, a manifold screw connection at the same time to fasten the protective cap. For this purpose, the protective cap is provided with a protruding fastening arm, for example a protruding tab.

Configuring the protective cap as a three-sided angular element overlapping the corner and cover has proven expedient for stability and fastening, and also makes it possible for all of those edges converging in a corner region of the engine, including the projecting parts, such as, for example, screws or the like, situated in this corner region to be rendered harmless, so that an extensive protective effect can be achieved with little outlay.

Further details and features of the invention emerge from the claims, the description below of the figures and from the drawings. The invention is explained below with reference to an exemplary embodiment.

### BRIEF DESCRIPTION OF THE DRAWINGS

FIG. 1 shows, in a highly schematized, sketched perspective illustration with a view from obliquely at the front and top, the rear, left corner region of the engine that is on the cylinder-head side and faces the passenger compartment of the vehicle, in conjunction with a protective cap overlapping this corner region,

FIG. 2 shows a separated, perspective illustration of the protective cap,

FIG. 3 shows a side view of the protective cap with the viewing direction on that side of the protective cap which is assigned to the left longitudinal side of the engine,

FIG. 4 shows a view of the protective cap in the direction of the arrow IV-IV in FIG. 3,

FIG. 5 shows a section through the protective cap along line V-V in FIG. 3, and

FIG. 6 shows a further sectional illustration through the protective cap along line VI-VI in FIG. 3.

### DETAILED DESCRIPTION OF THE INVENTION

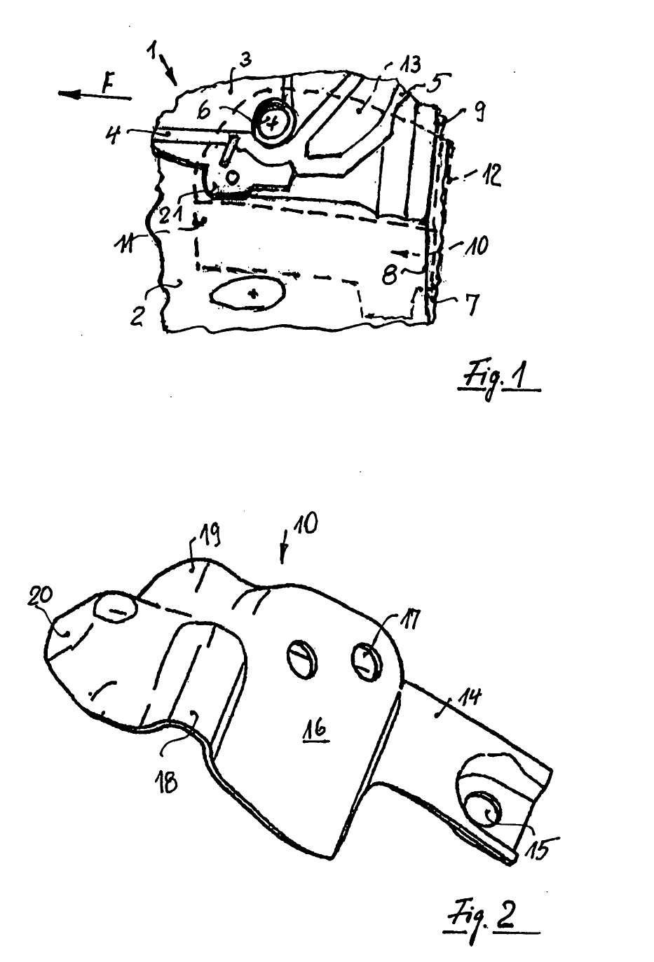

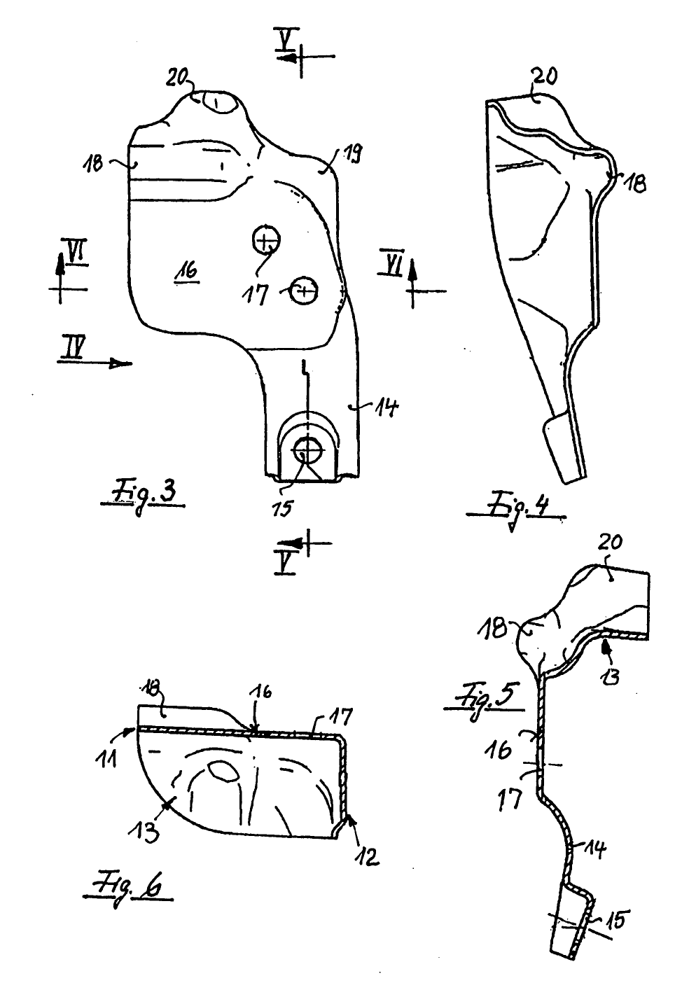

FIG. 1 shows the forward direction of travel F of a vehicle, and, in a viewing direction from laterally at the front and top, a perspective view of the left, rear corner region of the engine 1, which is arranged in the longitudinal direction in the engine compartment of the vehicle. The left longitudinal side wall of the engine is denoted by 2, and 3 designates the cylinder head cover which has longitudinal ribs 4 and transverse ribs 5 protruding upwards, designed as engine projections. A cylinder head cover screw 6 is also situated in the cutout shown.

The longitudinal side wall 2 of the engine merges at the rear end of the engine 1 into the front wall 7 with a sharp edge, the edge between the longitudinal side wall 2 of the engine and front wall 7 being denoted by 8 and the transverse edge upwardly adjoining it being denoted by 9. The described and illustrated corner region of the engine 1 is covered, as indicated by a dashed line, by a protective cap 10 which has a longitudinal limb 11 running alongside and a transverse limb 12. The protective cap 10 has a roof surface 13 which connects these limbs 11 and 12 in their upper edge region and overlaps the left, rear corner region of the cylinder head cover 3. Adjoining its longitudinal limb 11 adjacent to the edge 8, the protective cap 10 has a fastening arm 14 which protrudes in the opposite direction to the roof surface 13 and, in the region of an intake connection of the cylinder head, is screwed with respect to the longitudinal side wall 2 of the engine. If appropriate, one of the screw connections of the intake connection provided in the region thereof is also used. The relevant screw hole of the arm 14 is denoted by 15 and, by corresponding impressing of the arm 14 in the region of the screw hole 15 and/or by corresponding positioning and/or distortion of the fastening arm 14, a positional assignment of the fastening arm 14 or of the protective cap 10 to the engine 1 with planar bearing in the region of the fastening arm 14 and in the region of a bearing surface 16 is achieved. The bearing surface 16 is assigned to a mating surface assigned to the longitudinal wall 2 of the engine, with it also being possible in the region of this bearing surface 16 to undertake a fixing of the protective cap 10 with respect to the longitudinal side wall 2 of the engine via a screw connection. Corresponding screw holes are denoted by 17.

By means of the screw connections, the protective cap 10 is defined in a fixed position with respect to the engine 1. In order at least substantially to maintain the installation position thus predetermined even in the event of a crash, irrespective of the fact that, in the event of a crash, the engine 1 may move towards the front wall region (not illustrated) of the vehicle and is ultimately also supported against the front wall region via the protective cap 10 in the region thereof, the position of the protective cap 10 with respect to the engine 1 is ensured by the fact that the protective cap 10 is provided with formations 18, 19, 20 which cover protrusions and/or projections of the engine 1. As a result, at least a sliding in the protective cap 10 away from the overlapped corner region of the engine in the event of crash-induced loads is avoided, since the formations 18 to 20 are supported against the overlapped engine parts, to be precise in the region of the formation 18 against the longitudinal rib 4, in the region of the formation 19 against the longitudinal rib 5 and in the region of the formation 20 against the cylinder head screw 6. Although these mating surfaces, which are on the engine, are overlapped by the formations 18 to 20, and serve for the form-fitting support, form preferred supporting surfaces for the protective cap 10, they only exist, for example for the basic concept according to the invention, in order to achieve the positional securing of the protective cap 10, in the event of a crash, against parts of the engine 1 via a multi-dimensional support, with, in the described configuration according to the invention, the formation 18 also overlapping a projection 21 protruding to the longitudinal side wall 2. As a result, the protective cap 10 is supported in a form-fitting manner in the vertical and in the longitudinal and transverse direction and covers aggressive edges and projections which are situated in the corner region of the engine and via which lines lying between the engine and the delimitation on the vehicle of the engine compartment from the vehicle interior, in particular the front wall, could not only be squeezed, during a crash-induced displacement of the engine 1 towards the passenger interior, but could also be severely damaged and harmed. At risk in particular are the fuel lines which lead to the engine 1 and which could be affected by this corner region of the engine 1. Now, owing to the planar and flowing shaping for the protective cap 10, the fuel lines are, if appropriate, deformed but are not torn open or slit, as a result of which, in the case of fuel lines, fuel could escape and, in the case of electric lines, short circuits could come about, which would be associated in each case with a risk of fire.

An engine corner region which is conventionally aggressive from the point of view of line damage can therefore be rendered harmless with little outlay via a simple protective cap 10 which can be produced, for example, as a punched part. It is possible for the protective cap 10 to be formed such that it is both rigid, in particular by means of corresponding selection of material and/or wall thickness, and also flexible in some regions, so that the protective cap 10 has a structure which is partially easily deformable and, given a corresponding deformation, permits it to match mating structures and covers aggressive engine edges in a floating manner. Consequently, in the event of a crash, lines which may be acted upon are not damaged even if the mating structures are unfavourably shaped.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A protective device for fluid lines in a motor vehicle which have sections situated in an engine compartment of the motor vehicle and, during accident-induced displacements of an engine towards a passenger compartment, intersects with a displacement region of the engine, comprising a protective arrangement for the lines provided on the engine, wherein the protective arrangement is formed by a protective cap which covers an edge region of the engine facing the passenger compartment.

2. The protective device according to claim 1, wherein the protective cap has formations which, when the protective cap is secured with respect to the engine, overlap engine projections.

3. The protective device according to claim 2, wherein the formations are matched to the engine projections.

4. The protective device according to claim 3, wherein, in their installation positions with respect to the engine, the protective-cap formations have play with respect to the engine projections.

5. The protective device according to claim 2, wherein, in its displacement in relation to the engine, the protective cap can be supported in a multi-dimensionally displacement-limited manner via the formations and the engine projections overlapped by them.

6. The protective device according to claim 1, wherein the protective cap is assigned to a cylinder-head corner region of the engine.

7. The protective device according to claim 5, wherein the protective cap can be supported via surfaces of its formations against, as the engine projections, ribbings of the cylinder head cover that run in at least one of a longitudinal direction and a transverse direction of the engine.

8. The protective device according to claim 5, wherein the protective cap can be supported via its formations against at least one of projecting lengths and projections with respect to surfaces of the engine, and wherein the at least one of the projecting lengths and the projections run in at least one of a longitudinal direction and a transverse direction of the engine.

9. The protective device according to claim 8, characterized in that the projecting lengths, the projections, or both are formed by protrusions with respect to a border zone of a cylinder head cover.

10. The protective device according to claim 5, wherein the protective cap can be supported via a formation overlapping a head region of a cylinder head screw or a cylinder head cover screw.

11. The protective device according to claim 1, wherein the protective cap is a three-sided angular element which is open on its border and, based on its installation position with respect to the engine, has a bearing surface which is assigned to a longitudinal side wall of the engine, which is arranged in the longitudinal direction of the vehicle, and starting from which wall sides overlapping the cover and rear are provided.

12. The protective device according to claim 11, wherein the protective cap is provided with a fastening arm protruding with respect to the bearing surface.

13. The protective device according to claim 12, wherein the fastening arm is formed by a tab which is bent outwards on the border of the protective cap.

14. The protective device according to claim 2, wherein the protective cap is provided in a region of its roof surface overlapping the engine on the cylinder-head side with a formation which overlaps a cylinder head screw connection or a cylinder head cover screw connection.

15. The protective device according to claim 12, wherein the protective cap is provided in at least one of a region of the bearing surface and a region of the fastening arm with screw holes for a fastening screw connection.

16. The protective device according to claim 1, wherein the protective cap is designed as an inherently rigid cap.

17. The protective device according to claim 1, wherein the protective cap is designed as a cap which is inherently deformable at least in some regions.

18. The protective device according to claim 1, wherein the protective cap is designed as a punched part.

19. The protective device according to claim 1, wherein the edge region of the engine is a corner region.

20. The protective device according to claim 3, wherein, in its displacement in relation to the engine, the protective cap can be supported in a multi-dimensionally displacement-limited manner via the formations and the engine projections overlapped by them.
